(19) United States
(12) Patent Application Publication
(10) Pub. No.: US 2012/0257967 A1
(43) Pub. Date: Oct. 11, 2012

(54) METHOD AND CONTROLLER FOR GENERATING A BLADE PITCH ANGLE CONTROL SIGNAL AND WIND TURBINE COMPRISING THE CONTROLLER

(76) Inventors: Per Egedal, Herning (DK); Khanh Nguyen, Boulder, CO (US)

(21) Appl. No.: 13/079,998

(22) Filed: Apr. 5, 2011

(51) Int. Cl. F03D 7/04; F03D 7/00

(52) U.S. Cl. 416/1; 416/147

(57) ABSTRACT

A method for generating a blade pitch angle control signal for controlling a blade pitch angle of a rotating rotor blade for damping a rotor blade vibration, in particular an edgewise rotor blade vibration, of the rotating rotor blade is disclosed. The blade pitch angle control signal is generated such that it varies in accordance with a rotor blade vibration motion. A controller and a wind turbine are also disclosed.

### FIELD OF INVENTION

The present invention relates to a method and to a controller for generating a blade pitch angle control signal for controlling a blade pitch angle of a rotating rotor blade for damping a rotor blade vibration, in particular an edgewise rotor blade vibration, of the rotating rotor blade, wherein the rotor blade is in particular comprised in a wind turbine.

### ART BACKGROUND

During rotation of a rotor blade of a wind turbine, the rotor blade may oscillate according to one or more oscillation modes. In particular, under high loads and/or in high turbulence, in near wake, or with blade icing, a wind turbine blade may vibrate excessively, in particular in an edgewise direction which may lie at least approximately in a plane corresponding to the rotor plane being perpendicular to a rotor shaft at which the rotor blade is fixed. The oscillation of the rotor blade or the vibration of the rotor blade, in particular in the edgewise direction, may cause excessive vibration in the supporting structures, such as for example a bearing which supports the rotor shaft or other supporting or holding components.

A conventional method to handle vibration of a rotor blade may be to monitor the vibration of the nacelle which supports the rotor shaft and then stop the wind turbine when the vibration level exceeds a threshold value. However, while protecting the blade from damages, this approach may reduce the power production and thus efficiency of the wind turbine.

Further, another conventional countermeasure to react on excessive blade edgewise vibration may be to reduce the rotor speed, to operate the turbine at a reduced power level or to shut down the turbine entirely.

WO 2010/025732 A2 discloses a method for damping a wind turbine blade vibration, wherein a turbine blade comprises at least one wind turbine blade vibration damper having a number of damper surfaces in an interior of the blade and arranged to move relatively to each other during vibration of the blade.

However, it has been observed that the conventional methods and arrangement for damping a rotor blade vibration are not effective enough or may require expensive and difficulty to manufactured components.

There may be a need for a method and for a controller for generating a blade pitch angle control signal for controlling a blade pitch angle of a rotating rotor blade for damping a rotor blade vibration and there may also be a need for a wind turbine comprising the controller, wherein damping of a rotor blade vibration, in particular a vibration or oscillation in the edgewise direction, is improved or/and achieved in a simple and/or cost effective manner.

### SUMMARY OF THE INVENTION

This need may be met by the subject matter according to the independent claims. Advantageous embodiments of the present invention are described by the dependent claims.

According to an embodiment of the present invention, a method for generating (such as generating an electrical and/or optical signal) a blade pitch angle (an angle defining an orientation of the rotor blade with respect to a longitudinal axis of the rotor blade) control signal (such as an electrical control signal and/or an optical control signal) for controlling a blade pitch angle (defining an orientation of the rotor blade with respect to its longitudinal axis) of a rotating rotor blade (which rotor blade may be fixed at a rotor shaft rotating within a nacelle of a wind turbine, wherein the longitudinal axis of the rotor blade is in particular perpendicular to the rotor shaft, wherein the longitudinal axis of the rotor blade may define, upon rotation, the rotor plane) for damping (in particular reducing or decreasing an amplitude of the vibration) a rotor blade vibration (in particular comprising a periodic motion according to an oscillation mode, wherein the vibration may be characterized by a vibration frequency, a vibration amplitude and/or a vibration phase) of the rotating rotor blade is provided.

Thereby, the method comprises generating the blade pitch angle control signal such that it varies (in particular such that it varies in amplitude and/or direction, such that a sign of the angle control signal switches) in accordance (in particular with a same frequency) with a rotor blade vibration motion (comprising in particular a reciprocating motion of the rotor blade back and forth in particular at least approximately within the rotor plane). In particular, the generated blade pitch angle control signal may oscillate with a same frequency as the rotor blade vibration motion. Thus, in particular the generated blade pitch angle control signal may be adapted such that it causes in an alternating manner increasing the rotor blade pitch angle and decreasing the rotor blade pitch angle, when the blade pitch angle control signal is supplied to an actuator to turn the blade about its longitudinal axis based on the rotor blade pitch angle control signal.

According to an embodiment of the present invention, a method for damping a rotor blade vibration, in particular an edgewise rotor blade vibration, of a rotating rotor blade is provided, wherein the method comprises varying a blade pitch angle (in particular using an actuator which is controlled by the blade pitch angle control signal or which is controlled by a controller to which the blade pitch angle control signal is supplied) in accordance with a rotor blade vibration motion.

It should be understood that features (individually or in any combination) disclosed for a method for generating a blade pitch angle control signal for controlling a blade pitch angle may also be (individually or in any combination) applied to, used for or employed in a method for damping a rotor blade vibration according to an embodiment of the present invention and vice versa.

Generating the blade pitch angle control signal such that it varies in accordance with the rotor blade vibration motion, in particular an edgewise rotor blade vibration motion, may enable to vary the blade pitch angle in accordance (in particular synchronously) with the rotor blade vibration motion. Thereby, an effective damping of the rotor blade vibration motion may be achieved.

In particular, the rotor blade vibration motion may be a motion of the rotor blade which is periodic in time and which in particular moves the rotor blade forward and backward (in particular in the direction of rotation and opposite to the direction of rotation) at least approximately in the rotor plane being established by a plane perpendicular to the rotor shaft in which in particular the longitudinal axis of the rotor plane is arranged.

In particular, the rotor blade vibration motion may be a reciprocating motion being characterized by a rotor blade vibration frequency, a rotor blade vibration amplitude and a rotor blade vibration phase. In particular, the rotor blade vibration frequency may depend on a length, a material, a shape, and/or a weight of the rotor blade such that for example the rotor blade vibration frequency may decrease with an increasing length and may also decrease with an increasing mass of the rotor blade.

In particular, the blade pitch angle may be varied within a range of for example ±2°, ±1° or ±0.5°. In particular, the blade pitch angle may be increased when the blade moves forward and the blade pitch angle may be decreased when the blade section moves backward.

According to an embodiment of the present invention, the blade pitch angle control signal is generated such as to cause increasing the blade pitch angle, in particular relative to a nominal blade pitch angle (being a blade pitch angle which is nominally adjusted for the particular wind condition and energy production of the wind turbine), during a first portion (such as a first half of a repetition period of the rotor blade vibration) of a rotor blade vibration repetition period, and decreasing, in particular relative to the nominal blade pitch angle, the blade pitch angle during a second portion (such as a second half of the rotor blade vibration repetition period). Thus, the blade pitch angle control signal may be used to cause a reciprocating motion or varying of the blade pitch angle, wherein the reciprocating motion has the same frequency as the rotor blade vibration frequency.

Increasing the rotor blade pitch angle may be defined as moving away a leading edge of the rotor blade from the wind. Decreasing the rotor blade pitch angle may be defined as moving the leading edge of the rotor blade towards the wind.

Thus, in particular during the first portion of the rotor blade vibration repetition period the leading edge or upstream edge of the rotor blade is moved away from the wind and during the second portion of the rotor blade vibration repetition period the leading edge or upstream edge of the rotor blade is moved towards the wind. Thereby, an effective aerodynamic damping of the rotor blade vibration motion may be achieved.

According to an embodiment of the present invention, in the first portion of the rotor blade vibration repetition period the rotor blade has a first motion component due to the rotor blade vibration (which first motion component may for example be obtained by observing the rotor blade motion in a coordinate system which rotates with the rotating rotor shaft), wherein the first motion component is directed in a direction of the rotation of the rotor blade. Thus, the first motion component is directed in a forward direction of the rotating rotor blade.

In particular, while the rotor blade (due to the rotor blade vibration) moves in the forward direction an active damping may be achieved by increasing the blade pitch angle, i.e. by moving the leading edge of the rotor blade away from the wind.

According to an embodiment of the present invention, in the second portion or during the second portion of the rotor blade vibration repetition period the rotor blade has a second motion component (for example obtainable by observing the rotor blade motion in a coordinate system rotating in accordance, i.e. with same frequency, as the rotating rotor shaft) due to the rotor blade vibration, wherein the second motion component is directed opposite to the direction of the rotation of the rotor blade. Thus, during the second portion of the rotor blade vibration repetition period the rotor blade moves in a backward direction. In particular, an active aerodynamic damping may be achieved during the second motion component, while the rotor blade vibration causes a backward motion, to decrease the blade pitch angle, i.e. to move the leading edge of the rotor blade towards the wind.

According to an embodiment of the present invention, the rotor blade pitch angle control signal is generated such as to cause varying the blade pitch angle according to a trigonometric function having a repetition period equal to the rotor blade vibration repetition period, in particular according to a sine function. In particular, the blade pitch angle may vary with a frequency which is equal to the frequency of the rotor blade edgewise vibration.

According to an embodiment of the present invention, the blade pitch angle control signal is generated such as to cause varying the blade pitch angle during a high load condition (in particular a condition of a high or great or large wind speed which may also be defined as a situation in which the wind turbine produces a relatively high amount of power, for example an amount of power which is at least 70%, in particular at least 90% of, equal to or greater than the nominal amount of the wind turbine rated power), when an axial position of a radially outer portion (such as a tip of the rotor blade) is displaced in a wind direction (i.e. shifted in the wind direction) compared to a radially inner portion (such as for example a portion via which the rotor blade is connected to a rotor shaft), wherein the axial position is definable as a position along an axial direction, wherein the axial direction is parallel to the rotation axis of the rotor shaft, wherein in particular the axial direction is perpendicular to the rotor plane.

Thus, in particular, during the high load condition, the rotating rotor blade may not entirely lie within the rotor plane, but may define a cone having its tip at the inner portion of the rotor blade via which the rotor blade is connected to the rotor shaft. In particular, a shape of the cone may depend on a wind speed, on a material and/or a length of the rotor blade. In particular, the blade pitch angle control signal may only be generated or the blade pitch angle may only be varied, while or when the radially outer portion of the rotor blade is shifted relative to the radially inner portion of the rotor blade along the wind direction.

According to an embodiment of the invention, the blade pitch angle control signal is generated such as to cause maintaining the blade pitch angle at a nominal blade pitch angle during a low load condition (being for example characterized by relatively low wind speed or relatively low power production compared to the situation of the high load condition), when an axial position (as obtained or measured along the axial direction which is parallel to the rotation axis of the rotor shaft) of a radially outer portion (e.g. a tip of the rotor blade) of the rotor blade is displaced opposite (i.e. further towards the wind) to a wind direction compared to the radially inner portion of the rotor blade which radially inner portion is in particular connected to the rotor shaft.

In particular, the rotor blade may have a shape during idle time such that it is biased such that the tip of the rotor blade and the inner portion of the rotor blade do not lie within a same plane. Instead, the radially outer portion of the rotor blade may be shifted (during idle time) towards the wind compared to the radially inner portion of the rotor blade. Thus, also during a low load condition the rotating rotor blade may describe a cone having its tip at the radially inner portion but being open to towards the wind, while the cone during the high load condition may be open directing away from the wind. In particular, during the low load condition additional damping of the rotor blade vibration by actuating the rotor blade to cause changing its rotor blade angle may not be required, since during the low load condition there may already be an aerodynamic damping due to the shape of the rotor blade forming the cone.

According to an embodiment, the blade pitch angle control signal is generated such as to cause varying the blade pitch angle, when the rotor blade vibration motion has an amplitude exceeding a threshold, wherein the blade pitch angle control signal is generated such as to cause maintaining the blade pitch angle at a nominal blade pitch angle, when the rotor blade vibration motion has an amplitude being lower than or equal to the threshold. In particular, according to an embodiment, the threshold of the rotor blade vibration motion may be exceeded only during 1%-5% of an operation time of the wind turbine. Thus, the damping method may not continuously be applied, but may be applied only during certain time intervals, in which the amplitude of the rotor blade vibration motion exceeds the threshold. Thereby, the method may be simplified and negative effects due to the varying the blade pitch angle may be avoided.

According to an embodiment of the invention, the method for generating the blade pitch angle control signal further comprises determining the rotor blade vibration motion (in particular the edgewise rotor blade vibration motion) based on a wind turbine vibration signal (such as an electrical and/or optical signal) indicative of a wind turbine vibration, in particular based on a lateral vibration signal indicative of a lateral vibration of a nacelle supporting the rotor shaft to which the rotor blade is connected.

In particular, the nacelle or the wind turbine may comprise one or more acceleration sensors for sensing accelerations of the wind turbine, in particular the nacelle, along one or more directions, in particular along a horizontal direction for sensing side by side movements of the turbine, in particular the nacelle. In particular, it may not be required to determine the rotor blade vibration motion based on a signal generated by an acceleration sensor mounted at the rotor blade. Thereby, costs for determining the rotor blade vibration motion may be reduced.

According to an embodiment of the present invention, the determining the rotor blade vibration motion is further based on a rotor blade azimuthal position of the rotor blade. In particular, the rotor blade azimuthal position may determine the phase of the rotor blade. In particular, side-side vibrations of the nacelle may occur in accordance with the rotation of the one or more rotor blades connected to the nacelle.

According to an embodiment of the present invention, the blade pitch angle control signal is generated based on modulating the wind turbine vibration signal (such as by multiplying and/or forming a sum) according to a trigonometric function, in particular a cosine function, of the rotor blade azimuthal position. In particular, based on the side-side vibration of the nacelle or the wind turbine the rotor blade vibration motion may be deduced, even if several rotor blades, such as 2, 3, 4, 5, 6 or even more rotor blades, are connected to the rotor shaft, thus contributing to the side-side vibrations of the nacelle. In particular, having determined, calculated or estimated the motion (in particular the phase, the amplitude and the frequency) of the rotor blade vibration, the blade pitch angle control signal may be derived therefrom. Then, advantageously, the blade pitch angle control signal may be used as a control signal for controlling an actuator of the rotor blade for turning the rotor blade around its longitudinal axis, in order to vary the rotor blade pitch angle.

According to an embodiment of the present invention, the generating the blade pitch angle control signal comprises at least one of the following signal processing steps in series (or/and in parallel) on the modulated wind turbine vibration signal: band pass filtering (including removing signals having a frequency above or below certain thresholds); delaying (in particular comprising adding a time offset); amplifying (in particular comprising increasing, decreasing the signal such as to satisfy particular conditions, such as to fall within a predetermined range); restricting a change rate (such that the change rate, i.e. an amount of change with time, being within a particular range of a change rate); restricting a magnitude (such that the resulting signal lies within a predetermined range); adding to a nominal blade pitch angle signal (wherein the nominal blade pitch angle signal may be a normal blade pitch angle signal which is determined based on the wind condition and/or energy production state); and supplying to an actuator (arranged for turning the rotor blade around its longitudinal axis) configured for changing the blade pitch angle. Thereby, damage of mechanical components of the blade or the wind turbine may be reduced or even avoided.

According to an embodiment of the present invention, the wind turbine vibration signal is measured using an accelerometer, in particular mounted at a nacelle supporting a rotor shaft at which the rotor blade is connected. In particular, the accelerator may be configured to measure or sense an acceleration of the nacelle, in particular an acceleration in a horizontal direction such as to sense a side-side vibration of the nacelle. Thereby, the method may be simplified and may not require expensive equipment.

It should be understood that features (individually or in any combination) disclosed, explained, mentioned or applied to an embodiment of a method for generating a blade pitch angle control signal may as well be applied (individually or in any combination) to a method for varying a blade pitch angle and to a controller for generating a blade pitch angle control signal and vice versa.

According to an embodiment of the present invention, a controller for generating a blade pitch angle control signal for controlling a blade pitch angle of a rotating rotor blade for damping a rotor blade vibration, in particular an edgewise rotor blade vibration, of the rotating rotor blade is provided, wherein the controller is adapted to generate the blade pitch angle control signal such that it varies in accordance with a rotor blade vibration motion.

According to an embodiment, a wind turbine comprising the controller for generating a blade pitch angle control signal is provided, wherein the wind turbine is adapted to vary the blade pitch angle of the rotating rotor blade using the generated blade pitch angle control signal. In particular, the wind turbine may comprise one, two, three, four, five or even more rotor blades which may all be controlled regarding their blade pitch angles using the controller or a number of controllers for generating respective blade pitch angle control signals.

The controller may be implemented in hardware and/or software. According to an embodiment, a program element is provided which comprises instructions which, when carried out in a processor, control or carry out a method for generating a blade pitch angle control signal according to an embodiment, as described above. Further, a data carrier having the above-mentioned program element stored is provided.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this document.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWINGS

Embodiments of the present invention are now described with reference to the accompanying drawings. The invention is not restricted to the illustrated or described embodiments.

FIG. 1 schematically illustrates a method for varying a blade pitch angle according to an embodiment of the invention;

FIG. 2 schematically illustrates the root cause of blade edgewise motion which may be damped according to methods and embodiments of the present invention;

FIG. 3 schematically illustrates modes of blade loads transferred to the nacelle of a wind turbine;

FIG. 4 illustrates blade edgewise frequencies in the rotating blade frame and nacelle frame considered according to a method of the present invention;

FIG. 5 schematically illustrates a signal diagram for a blade edge damping algorithm or controller according to an embodiment of the present invention; and

FIG. 6 illustrates graphs of a nacelle vibration and a blade edge vibration which may be damped according to methods of the present invention.

### DETAILED DESCRIPTION

The illustration in the drawings is in schematic form.

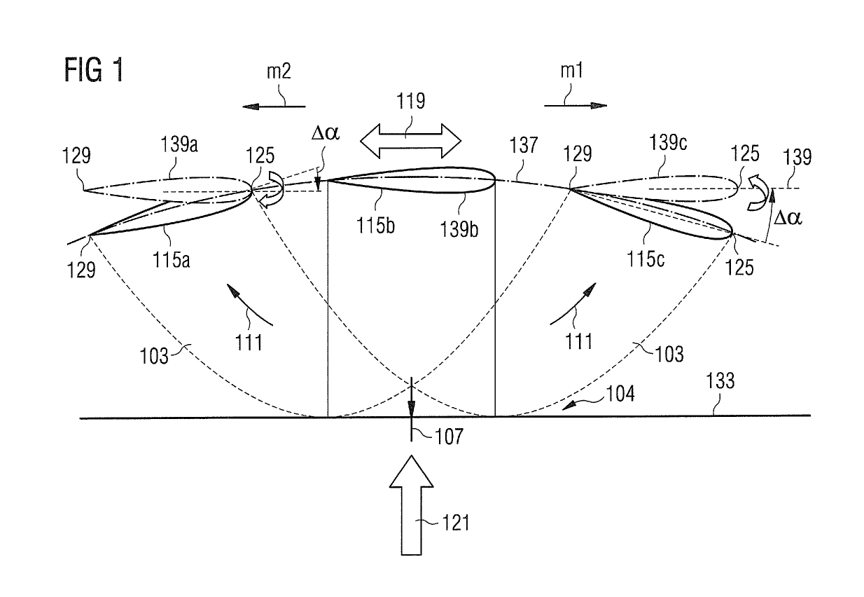

FIG. 1 schematically illustrates a method for varying a blade pitch angle according to an embodiment of the present invention. In particular, FIG. 1 illustrates damping of a rotor blade edgewise motion in a high load condition of an operating wind turbine.

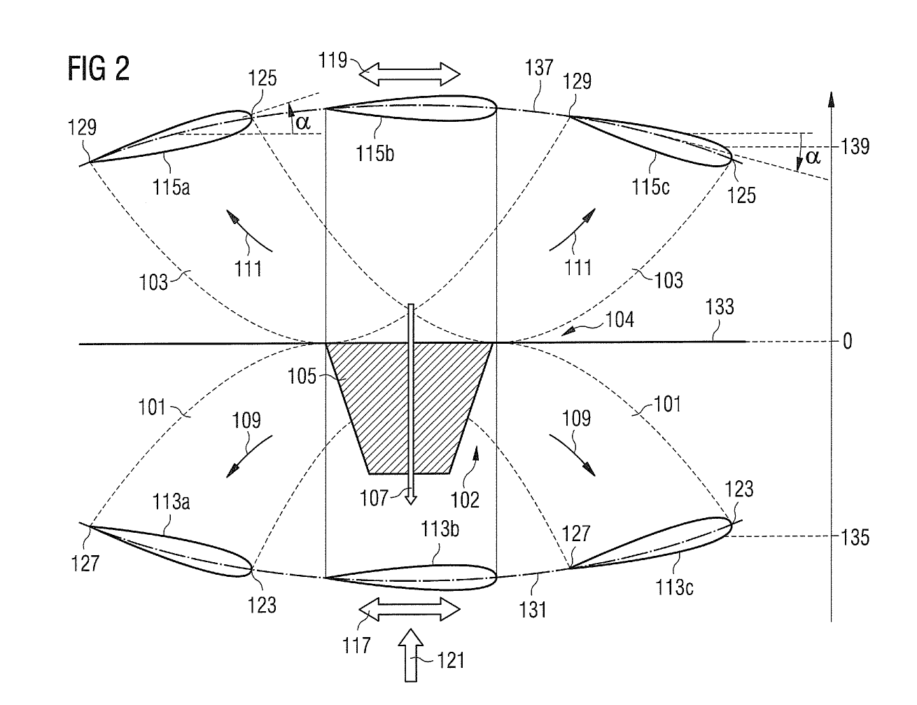

An undamped edgewise motion of the rotor blade is schematically illustrated in FIG. 2 for a low load condition as well as for a high load condition. In FIG. 2 a single rotor blade 101, 103 is illustrated as viewed approximately along its longitudinal axis, wherein the rotor blade 101 represents a situation during a low load condition, while the rotor blade 103 represents a situation during a high load condition.

At a radially inner portion 102, 104 the rotor blade 101, 103 is connected to a rotor hub 105 which rotates around a rotation axis 107. The rotor hub 105 may be connected to a rotor shaft. In particular, the rotor hub or the rotor shaft may be rotatably supported within a nacelle of the wind turbine. Further, the nacelle may comprise an accelerometer for measuring a wind turbine vibration signal indicative of a vibration of the wind turbine, in particular a vibration of the nacelle.

Further, the rotor blade 101, 103 extends from the radially inner portion 102, 104, where the rotor blade 101, 103 is connected to the rotor hub 105, along its longitudinal axis 109, 111 towards a radially outer portion 113, 115. In particular, due to a blade edgewise motion being a reciprocating motion in directions indicated by the double arrow 117, 119, the radially outer portion 115, 113 will be positioned at different locations 113a, 113b, 113c and 115a, 115b, 115c, respectively, representing different positions during the blade edgewise motion.

Due to wind which moves along a direction 121 the rotor blade 101, 103 rotates in a clockwise direction when viewed in a direction along the wind direction 121. Thus, in FIG. 2 (and also in FIG. 1) the rotor blade 101, 103 moves in a direction to the right due to the rotation around the rotation axis 107. If an observer rotates with the rotating rotor blade 101, 103 the observer will observe the blade edgewise motion as depicted in FIG. 2. The rotor blade 101, 103 comprises a leading edge 123, 125 and a trailing edge 127, 129.

In particular, during the low load condition the rotor blade 101 moves along the path 131, in particular the radially outer portion 113 moves along the path 131, wherein the radially outer portion 113 is located in the different positions labelled 113a, 113b and 113c being associated with different time points within a repetition period T of the blade edgewise motion. During the low load condition the wind speed is lower than during the high load condition.

The rotor blade 101 representing the situation during the low load condition is biased or bent towards the wind such that the radially inner portion 102 is axially (i.e. along the rotation axis 107) shifted relative to the radially outer portion 113 along the wind direction 121. In particular, the radially inner portion 102 is axially located within the rotor plane 133. In particular, an axial position of the radially outer portion 113 of the rotor blade 101 may be measured as a distance along the rotation axis 107 from the rotor plane 133. Thus, the axial position 135 of the radially outer portion 113 of the rotor blade may be associated with a negative value during the low load condition due to the biasing of the rotor blade 101.

During the high load condition the radially outer portion 115 of the rotor blade 103 moves, due to edgewise vibration, along the path 137, wherein the rotor blade assumes positions 115a, 115b and 115c during different time points of the reciprocating blade edgewise motion. In contrast to the situation during the low load condition the axial position 139 of the radially outer portion 115 of the rotor blade 103 is shifted relative to the radially inner portion 104 along the wind direction, such that the radial position 139 of the radially outer portion 115 of the rotor blade 103 during the high load condition may be associated with a positive value, when measured as a distance to the rotor plane along the rotation axis 107.

Due to a fixed longitudinal length L of the rotor blade 101, 103 a rotor blade pitch angle α changes upon the blade edgewise motion along the path 137 such that the blade pitch angle α is greater than 0° for the situation of the position 115a of the radially outer portion 115 and such that the blade pitch angle α is negative, thus smaller than 0°, for the position 115c of the radially outer portion 115 of the rotor blade 103. This varying of the blade pitch angle is due to the fixed length of the rotor blade 103 and the connection of the rotor blade 103 at the radially inner portion 104. This kind of varying of the rotor blade pitch angle α does not damp the blade edgewise motion but instead has a negative damping effect.

Different rotor blade pitch angles α are also observed during the low load condition but in this case in the situation 113a the rotor blade pitch angle is negative, while in the situation 113c the rotor blade pitch angle is positive. Thereby, a damping effect is achieved such that for the low load condition additional varying the rotor blade pitch angle α may not be required.

FIG. 1 schematically illustrates the high load condition of the rotor blade 103, wherein the rotor blade radially outer portions 115a, 115b and 115c represent the situation without varying the rotor blade pitch angle according to an embodiment of the present invention, while the illustrations 139a, 139b and 139c illustrate the radially outer blade portions while varying the rotor blade pitch angle according to an embodiment of the present invention.

In particular, the radially outer portion 139a has a lower blade pitch angle than the radially outer portion 115a which represents the uncontrolled radially outer blade pitch portion. In particular, the blade pitch angle is lower by an amount Δα. In contrast, the radially outer portion 139c has a greater pitch angle by an amount Δα compared to the radially outer portion 115c which represents the uncontrolled situation. In particular, the radially outer portion of the rotor blade 103 moves from left to right (i.e. in the direction of rotation) in a first half of the repetition period T of the blade edgewise motion. During this first half of the repetition period the rotor blade pitch angle α may be varied to impose a continuously increasing blade pitch angle offset Δα such that the blade pitch angle offset is maximal at the position 139c. In particular, during a second half of the repetition period T the rotor blade radially outer portion 115 moves from the right to the left (i.e. opposite to the rotation direction). During this second half of the repetition period the rotor blade pitch angle may continuously be decreased such as the maximum decrease is reached at the position 139a.

In particular the rotor blade may be rotated around its longitudinal axis, such the pitch angle as measured at the radially outer portion 139a, 139b, 139c of the rotor blade does not change during the edgewise vibration motion, as illustrated in FIG. 1 showing the radially outer portion 139a, 139b, 139c of the rotor blade at a same orientation.

In particular FIG. 2 shows the edgewise motion of a blade section as viewed from above (a wind turbine) and when the blade is at the 12 o'clock position. The rotor, consisting of a number of blades, rotates clockwise as view from the wind direction. In this view, it is assumed that the observer is moving along with the blade as it rotates, seeing only the blade vibration. For an observer not in this reference frame, say from the ground, looking at a blade would see both its rotation and vibration. The rotor plane is a reference plane perpendicular to the main shaft axis.

FIG. 2 shows two scenarios, low loads and high loads. Under low loads, the blade section moves along Path 131, which is ahead of the rotor plane due to blade precone and pre-bend. Blade precone is the angular mounting of the blade at the hub and pre-bend is the built-in curvature of the blade. Both are used to place the blade tip away from the tower to prevent a blade from tower strikes. Under high loads, the blade section is displaced backward (to the top of the figure) since it carries a larger lift. Thus, the blade segment moves along Path 137. In the FIG. 2, forward motion of the blade section is to the right and backward motion to the left.

A major insight of the present invention is that the blade section moves along an arc with opposite orientation under low and high loads. Under low loads, the forward motion of the blade section experiences an increase in angle of attack as it move along Path 131. The higher angle of attack increases in the inplane force that resists the forward motion. The inplane force is increased due to the backward tilt of the lift vector and the drag increase. When the blade section moves back, the resisting inplane force is reduced due to the lower angle of attack, leading to the forward tilt of the lift vector and the drag reduction. The blade section encounters a resisting force that opposes its motion, a positive damping effect, when it moves along Path 131.

When the blade section moves along Path 137 under high loads, it experiences a negative damping effect. A forward motion of the blade section reduces the angle of attack, which reduces the inplane force that resists the motion. As the angle of attack is reduced, the lift vector tilts forward and the drag decreases, and both effects induce further forward motion. Likewise, as the blade section moves back, the higher angle of attack increases the edgewise force, which causes the blade to move back further. Thus, the blade section has negative edgewise damping under high loads since its motion induces a change in the force components that further increase its motions. This results in an unstable blade edgewise motion, typically vibrating at the blade first edgewise bending mode. Note that this instability can be triggered by a severe unsteady aerodynamic event such as icing, near wake, and high turbulence.

A solution to the blade aeroelastic instability described above is to apply a blade pitch to counter the adverse effect of the angle of attack change as the blade section moves along Path 137 as shown in FIG. 1. Essentially, this is an active damping method in which the blade pitch is increased when the blade section moves forward and is reduced for the backward movement. The blade pitch schedule may be sinusoidal; the excitation frequency is dictated by the blade first edge bending mode since the instability occurs at this frequency. The blade pitch amplitude may be small, in the order of ½ deg. This method depends on the ability to detect the blade edgewise motion, which is described next.

Note that in this context, increasing blade pitch angle increases the blade section angle of attack. This is opposite to most standard wind turbine convention where increasing pitch angle reduces blade section angle of attack.

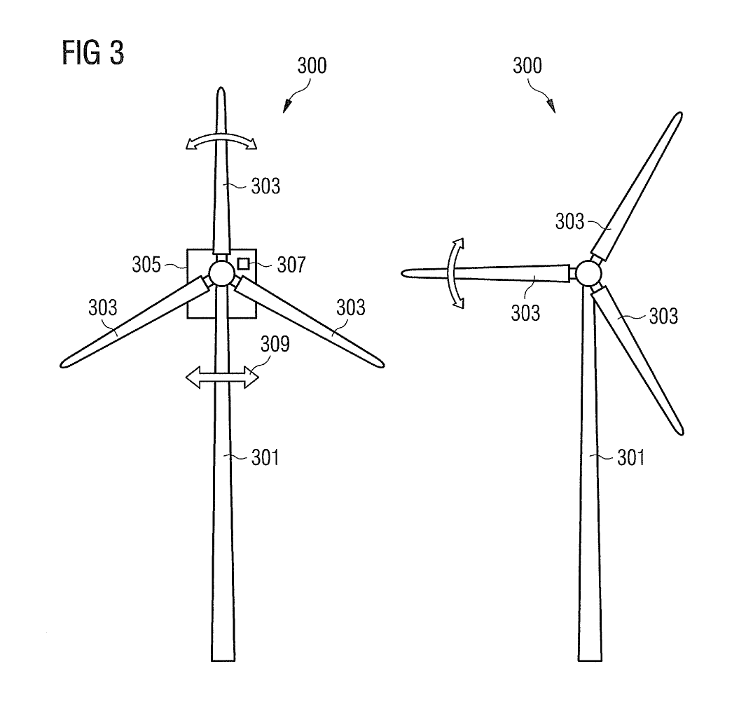

FIG. 3 schematically illustrates a wind turbine 300 comprising a wind turbine tower 301 and three rotor blades 303. Further, the rotor blade 300 comprises a nacelle 305 supporting a rotation shaft at which the three rotor blades 303 are connected. The nacelle 305 comprises an accelerometer 307 for measuring a nacelle vibration along the direction indicated by double arrow 309 which is directed in the horizontal direction, such that the accelerometer 307 is adapted to measure a side-side vibration of the nacelle 305.

The detection method is based on a single nacelle sensor 307, which avoids the needs for blade-mounted sensors. The vibrations of the single blades are determined from the G-sensor (an accelerometer) 307 placed in the nacelle. It makes use of the modulation of the vibration in the blade, caused by the rotation of the wind turbine rotor.

When a blade is in the vertical position (6 or 12 o'clock), the blade edgewise vibration is transferred directly to the nacelle side-side vibration. When the blade is in the horizontal position (3 or 9 o'clock), the blade edgewise vibration is not transferred to the nacelle side-side vibration (FIG. 3)

Based on the Multi-Blade Coordinate (MBC) Transformation, the blades inplane accelerations are transferred to the nacelle with a 1P (one per rotor revolution) modulation

$${a}_{X} = {a}_{A} \cdot cos ( φ ) + {a}_{B} \cdot cos ( φ - \frac{2 \cdot π}{3} ) + {a}_{C} \cdot cos ( φ - \frac{4 \cdot π}{3} )$$

where aX is the nacelle side-side acceleration, aA is blade A edgewise acceleration, aB is blade B edgewise acceleration, aC is blade C edgewise acceleration, and φ is the rotor azimuth angle.

Modulation the aX signal with respect to the individual blade azimuth position gives three new signals defined by:

$${am}_{A} = {a}_{X} \cdot cos ( φ )$$

$${am}_{B} = {a}_{X} \cdot cos ( φ - \frac{2 \cdot π}{3} )$$

$${am}_{C} = {a}_{X} \cdot cos ( φ - \frac{4 \cdot π}{3} )$$

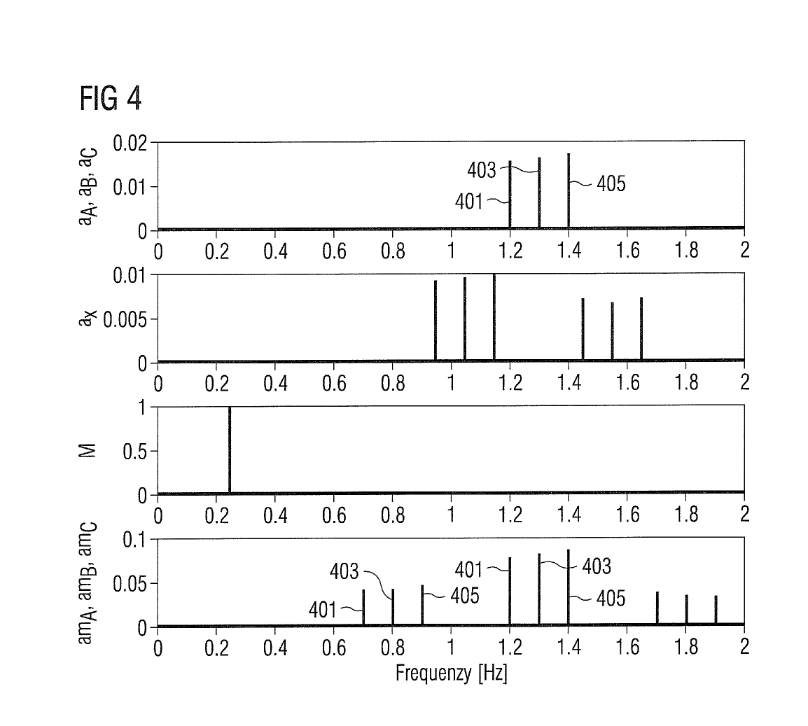

FIG. 4 schematically illustrates four graphs, a first graph, a second graph, a third graph and a fourth graph, wherein on an abscissa the frequency in Hertz (Hz) is indicated. By analyzing the acceleration signal delivered by the accelerometer 307 located within the nacelle 305 the vibration of the individual rotor blades may be derived, wherein in particular the peaks 401 depicted in the fourth graph of FIG. 4 correspond to a first blade A, the peaks 403 correspond to a second blade B and the peaks 405 correspond to a third blade C, wherein all the blades A, B and C are mounted at the rotor shaft supported within the nacelle 305 of the wind turbine 300.

The third graph in FIG. 4 shows a 1P modulation (maximum when blade is on top).

FIG. 4 shows that the frequency spectrum of amA has its peak at the same frequency as the blade edge frequency aA. It can also be seen that the blade frequency can not be separated just by looking at the frequency spectrum of the nacelle acceleration (aX).

The active damping method is made by identifying the single blade vibration with the mentioned method above, and then feed this signal into the pitch reference for the blade servo control. By pitching the individual blade at the right phase (relative to the blade edgewise motion), excessive blade vibration can be avoided.

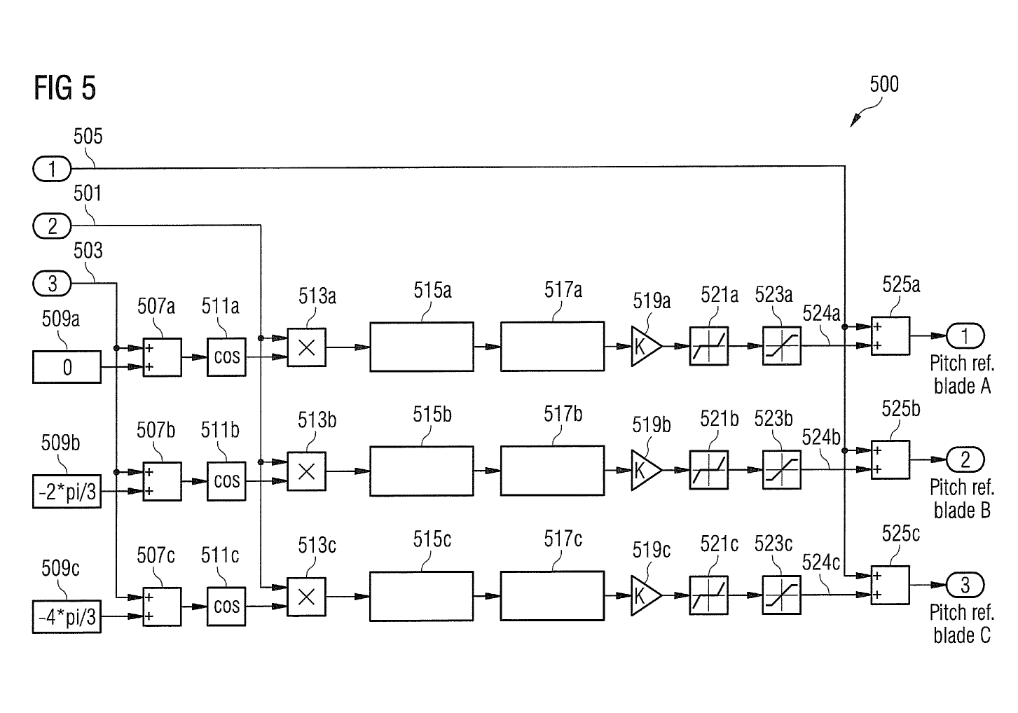

A signal diagram for the vibration damping system is show in FIG. 5 FIG. 5 schematically illustrates a controller 500 for generating a blade pitch angle control signal for controlling a blade pitch angle of a rotating rotor blade according to an embodiment of the present invention. As input signals the controller 500 uses a signal 501 indicative of nacelle side-side vibrations (for example as acquired by the accelerometer 307 illustrated in FIG. 3), a rotor azimuth position 503 being indicative of an azimuthal position of the rotor, and a common blade pitch reference 505 from a speed controller. Thereby, the common blade pitch reference 505 corresponds to a nominal blade pitch angle which is based on a running condition or speed condition of the wind turbine or is based on a wind speed.

For each rotor blade of the wind turbine 300, i.e. the rotor blade A, the rotor blade B and the rotor blade C, the controller 500 comprises a line of processing steps which are performed in series. For rotor blade A the controller 500 comprises an adder 507a which adds the rotor azimuth position 503 to an azimuth offset obtained from a fixed signal source 509a. The rotor azimuth position 503 is added to the fixed azimuth offset 509a and fed to a cosine function component 511a. Using a multiplier 513a the nacelle side-side vibration 501 is multiplied by the signal output by the cosine function component 511a. Further, a bandpass is applied to this multiplied signal using a bandpass filter 515a. After filtering a delay or a filter 517a is applied and the signal is amplified by the gain 519a. Thereupon, a dead zone element 521a is applied, a saturation element 523a is applied after which the resulting signal 524a is added using an adder 525a to the common blade pitch reference 505. The adder finally outputs the pitch reference for rotor blade A, i.e. the signal which is finally supplied to an actuator for actuating the rotor blade pitch angle. The saturation element 525a outputs a blade pitch angle control signal 524a.

Analogous processing steps are performed for the other rotor blades B and C, as illustrated in FIG. 5.

In particular, the nacelle side-side vibrations is modulated with cosine to azimuth position of the individually blades. Then the signals are band pass filtered to retain only the blade edgewise components. The signals are then adjusted in phase by a filter or a delay, and then adjusted in gain by multiply a factor. Before this signal is added to the individual pitch reference, it is sent through a dead zone function to remove small changes due to noise, and then saturated to avoid high pitch activity.

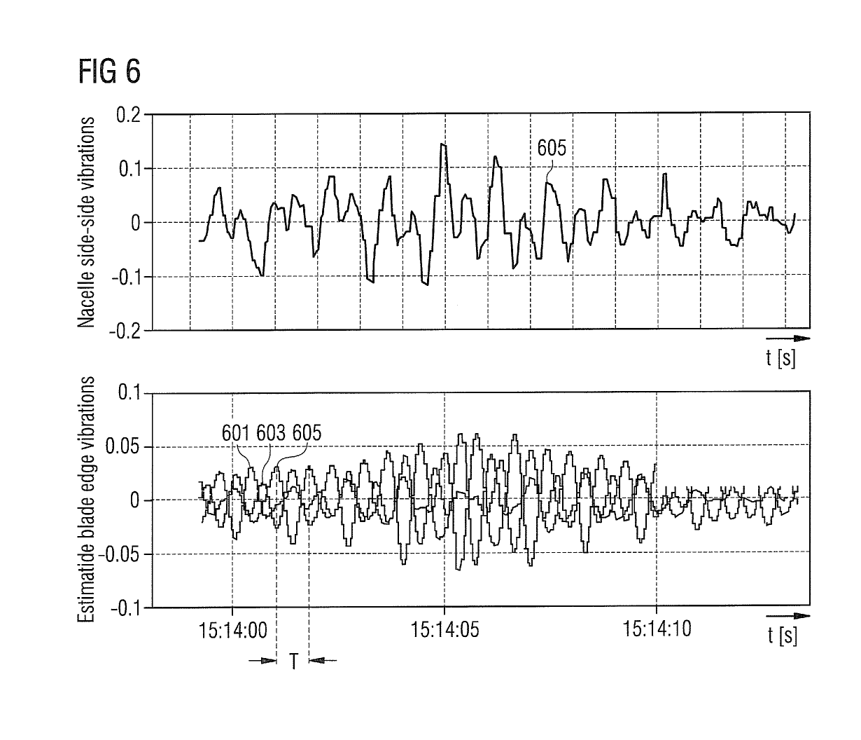

FIG. 6 illustrates an upper and a lower graph, wherein on the respective abscissas the time (t) in seconds (s) is indicated. On the ordinate of the upper graph of FIG. 6 the nacelle side-side vibrations are indicated.

Upon processing the nacelle side-side vibrations 605 illustrated in the upper graph of FIG. 6 the estimated blade edge vibrations of rotor blade A (curve 601), rotor blade B (curve 603) and rotor blade C (curve 605) may be derived in the lower graph. In particular, the curve 601 may represent the blade pitch angle control signal 524a, the curve 603 may represent the blade pitch angle control signal 524b and the curve 605 may represent the blade pitch angle control signal 524c, as illustrated in FIG. 5.

According to an embodiment the detection of the rotor blade edgewise motion may be performed in analogy to the method as disclosed in the document EP 2 179 337 A1. Thereby, this document is entirely incorporated into this application.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

1.-15. (canceled)

16. A method for generating a blade pitch angle control signal for controlling a blade pitch angle of a rotating rotor blade for damping a edgewise-rotor-blade vibration of the rotating rotor blade, the method comprising:
generating a blade pitch angle control signal that varies in accordance with a rotating-rotor-blade-vibration motion.

17. The method according to claim 16, wherein the blade pitch angle control signal is generated to cause:
increasing the blade pitch angle, relative to a nominal blade pitch angle, during a first portion of a rotor blade vibration repetition period
decreasing the blade pitch angle, in particular relative to the nominal blade pitch angle, the blade pitch angle during a second portion of the rotor blade vibration repetition period.

18. The method according to claim 17, wherein the first portion of the rotor blade vibration repetition period the rotor blade includes a first motion component due to the rotor blade vibration, wherein the first motion component is directed in a direction of the rotation of the rotor blade.

19. The method according to claim 17, wherein during the second portion of the rotor blade vibration repetition period the rotor blade has a second motion component due to the rotor blade vibration, wherein the second motion component is directed opposite to the direction of the rotation of the rotor blade.

20. The method according to claim 16, wherein the blade pitch angle control signal is generated to cause varying the blade pitch angle according to a trigonometric function having a repetition period equal to the rotor blade vibration repetition period, in particular according to a sine function.

21. The method according to claim 16, wherein the blade pitch angle control signal is generated to cause varying the blade pitch angle during a high load condition, when an axial position of a radially outer portion of the rotor blade is displaced in a wind direction compared to a radially inner portion of the rotor blade, wherein in particular the radially inner portion of the rotor blade comprises a fixing portion via which the rotor blade is connected to a rotor shaft (105).

22. The method according to claim 22, wherein the radially inner portion of the rotor blade comprises a fixing portion via which the rotor blade is connected to a rotor shaft.

23. The method according to claim 16, wherein the blade pitch angle control signal is generated to cause maintaining the blade pitch angle at a nominal blade pitch angle during a low load condition, when an axial position of a radially outer portion of the rotor blade is displaced opposite to a wind direction compared to a radially inner portion of the rotor blade.

24. The method according to claim 16,
wherein the blade pitch angle control signal is generated to cause varying the blade pitch angle, when the rotor blade vibration motion has an amplitude exceeding a threshold, and
wherein the blade pitch angle control signal is generated such as to cause maintaining the blade pitch angle at a nominal blade pitch angle, when the rotor blade vibration motion has an amplitude being lower than or equal to the threshold.

25. The method according to claim 16, further comprising:
determining the rotor blade vibration motion based on a wind turbine vibration signal indicative of a wind turbine vibration, in particular based on a lateral vibration signal indicative of a lateral vibration of a nacelle supporting a rotor shaft to which the rotor blade is connected.

26. The method according to claim 25, wherein the determining the rotor blade vibration motion is further based on a rotor blade azimuthal position of the rotor blade.

27. The method according to claim 26, wherein the blade pitch angle control signal is generated based on modulating the wind turbine vibration signal according to a trigonometric function of the rotor blade azimuthal position.

28. The method according to claim 27, wherein trigonometric function is a cosine function.

29. The method according to claim 28, wherein the generating the blade pitch angle control signal comprises at least one signal processing steps in series on the modulated wind turbine vibration signal, the signal processing steps selected from the group consisting of band pass filtering, delaying, amplifying, restricting a change rate, restricting a magnitude, adding to a nominal blade pitch angle signal, and supplying to an actuator configured for changing the blade pitch angle.

30. The method according to claim 25, wherein the wind turbine vibration signal is measured using an accelerometer.

31. The method according to claim 30, wherein accelerometer is mounted at a nacelle supporting a rotor shaft at which the rotor blade is connected.

32. A controller for generating a blade pitch angle control signal for controlling a blade pitch angle of a rotating rotor blade for damping a rotor blade vibration, in particular an edgewise rotor blade vibration, of the rotating rotor blade, wherein the controller is adapted to
generate the blade pitch angle control signal such that it varies in accordance with a rotor blade vibration motion.

33. A wind turbine comprising the controller according to claim 32, wherein the wind turbine is adapted to vary the blade pitch angle of the rotating rotor blade using the generated blade pitch angle control signal.
